(19) United States
(12) Patent Application Publication
(10) Pub. No.: US 2008/0143876 A1
(43) Pub. Date: Jun. 19, 2008

(54) VIDEO STREAM TIMING DETECTION

(76) Inventors: JAMES KOURAMANIS, Scarborough (CA); Chun Wang, Markham (CA)

Correspondence Address: MINTZ, LEVIN, COHN, FERRIS, GLOVSKY AND POPEO, P.C;ATTN: PATENT INTAKE CUSTOMER NO. 30623, ONE FINANCIAL CENTER, BOSTON, MA, 02111, US

(21) Appl. No.: 11/839,361

(22) Filed: Aug. 15, 2007

Related U.S. Application Data
(60) Provisional application No. 60/824,204, filed on Aug. 31, 2006.

(51) Int. Cl. H04N 5/44

(52) U.S. Cl. 348/553

(57) ABSTRACT

A video signal identification system including an input module configured to receive an unknown video signal, a video signal processing module configured to process known video signals, and a processor coupled to the input module and to the video signal processing module and configured to determine and store information indicative of characteristics of the unknown video signal such that the unknown video signal becomes a known video signal that can be processed by the video signal processing module.

### RELATED APPLICATIONS

This application claims the benefit of U.S. Provisional Application No. 60/824,204, filed on Aug. 31, 2006, which is incorporated by reference herein in its entirety.

### BACKGROUND

Today, many forms of video information are provided from information sources, such as cable companies, DVD players, and gaming consoles, to receivers, such as televisions in people's homes. Thus, an example of such information is digital television (DTV) information such as a high-definition television (HDTV) signal. Providing video information to a receiver typically involves processing the information according to one or more standardized specifications depending on, for the example, the method used to provide the video information to the receiver. The receiver is typically configured to receive and decode the video information according to the particular standard used. The video information provided by an information source typically includes “active” information (e.g., the portion of the video information corresponding to the displayed image) and “ancillary” information used by a receiver to properly display the active information (e.g., vertical synchronization (VS) information, horizontal synchronization (HS) information, pixel clocks, and/or a DACTIVE signal).

In order for a video signal processing system to process video information provided by an information source, several characteristics about the video information are desired to be known by the processing system. Characteristics of the video signal can include many attributes such as a polarity of the video signal, where edges are located in the video signal, a location of an active edge in the signal, a clock frequency used to transmit the video signal, a threshold value corresponding to the video signal, etc. The characteristics of the video signal, however, typically vary greatly depending on many factors such as where a receiver is located (e.g., different countries use different standards), the method used to provide the video information (e.g., via terrestrial broadcast, or via a cable distribution system), and/or the type of video information provided (e.g., video game images, television programming, computer graphics, etc.).

### SUMMARY

In general, in an aspect, the invention provides a video signal identification system including an input module configured to receive an unknown video signal, a video signal processing module configured to process known video signals, and a processor coupled to the input module and to the video signal processing module and configured to determine and store information indicative of characteristics of the unknown video signal such that the unknown video signal becomes a known video signal that can be processed by the video signal processing module.

Implementations of the invention may provide one or more of the following features. The processor is configured to detect a polarity of at least a sub-portion of the unknown video signal, detect the presence of a vertical synchronization signal in the unknown video signal, detect the presence of a horizontal synchronization signal in the unknown video signal, provide, if a vertical synchronization signal is present in the unknown video signal, information related to a characteristic of the vertical synchronization signal, provide, if a horizontal synchronization signal is present in the unknown video signal, information related to a characteristic of the horizontal synchronization signal, wherein the video signal processing module is configured to recognize a type of the unknown video signal based upon the characteristic information provided by the processor. The processor is further configured to determine a vertical synchronization period of vertical synchronization pulses included in the vertical synchronization signal.

Implementations of the invention may also provide one or more of the following features. The processor is further configured to determine a consistency of the vertical synchronization signal by tracking the vertical synchronization period. The processor is further configured to determine a horizontal synchronization period of horizontal synchronization pulses included in the horizontal synchronization signal. The processor is further configured to determine a consistency of the horizontal synchronization signal by tracking the horizontal synchronization period. The processor is further configured to determine whether the unknown video signal includes letterboxed video. The processor is further configured to determine starting and ending locations of a letterboxed image included in the unknown video signal. The processor is further configured to determine whether the unknown video signal includes interlaced video. The processor is further configured to determine a location of first and last pixels of a horizontal line corresponding to a DACTIVE region of the unknown video signal.

In general, in another aspect, the invention provides a video signal identification method including receiving an unknown video signal, converting the unknown video signal into a known video signal by determining information indicative of characteristics of the unknown video signal, storing the information in a memory, and processing the known video signal using the information.

Implementations of the invention may provide one or more of the following features. Converting the unknown video signal into the known video signal includes detecting a polarity of at least a sub-portion of the unknown video signal, detecting the presence of a vertical synchronization signal in the unknown video signal, detecting the presence of a horizontal synchronization signal in the unknown video signal, providing, if a vertical synchronization signal is present in the unknown video signal, information related to a characteristic of the vertical synchronization signal, and providing, if a horizontal synchronization signal is present in the unknown video signal, information related to a characteristic of the horizontal synchronization signal. Converting the unknown video signal into the known video signal includes determining a vertical synchronization period of vertical synchronization pulses included in the vertical synchronization signal. Converting the unknown video signal into the known video signal includes determining a consistency of the vertical synchronization signal by tracking the vertical synchronization period.

Implementations of the invention may also provide one or more of the following features. Converting the unknown video signal into the known video signal includes determining a horizontal synchronization period of horizontal synchronization pulses included in the horizontal synchronization signal. Converting the unknown video signal into the known video signal includes determining a consistency of the horizontal synchronization signal by tracking the horizontal synchronization period. The method further includes determining whether the unknown video signal includes letterboxed video. The method further includes determining starting and ending locations of a letterboxed image included in the video signal. The method further includes determining if the unknown video signal includes interlaced video. The method further includes determining a location of first and last pixels of a horizontal line corresponding to a DACTIVE region of the unknown video signal.

Various aspects of the invention may provide one or more of the following capabilities. Characteristics of an unknown video stream can be detected. A video processing system can process more types of video streams as compared with prior techniques. The presence of a valid video information stream can be detected. Changes in an incoming video stream can be detected in a more efficient manner compared to prior techniques.

These and other capabilities of the invention, along with the invention itself, will be more fully understood after a review of the following figures, detailed description, and claims.

### BRIEF DESCRIPTION OF THE FIGURES

FIG. 1 is a block diagram of a video stream processing system.

FIG. 2 is a block diagram of a register contained in the video stream processing system shown in FIG. 1.

FIG. 3 is a functional block diagram of a timing detection system contained in the video stream processing system.

FIGS. 4-5 are waveform diagrams illustrating synchronization signals and corresponding edge locations.

FIG. 6 is a graph slowing periods of a synchronization signal and a varying threshold range.

FIG. 7 is a timing diagram illustrating a VS signal and an HS signal.

FIG. 8 is a timing diagram illustrating a VS signal and an HS signal.

FIGS. 9-12 illustrate video windows including an active window.

FIG. 13 is a timing diagram illustrating a VS signal, an HS signal, a DACTIVE signal, and a pixel clock.

FIGS. 14-15 illustrate video windows including letterboxed images.

FIGS. 16a-16b are a flowchart of a process for performing timing detection on an incoming video information stream using the system shown in FIG. 1.

### DETAILED DESCRIPTION

Embodiments of the invention provide techniques for detecting and documenting transmission characteristics of an incoming video stream. For example a video processing system includes a timing detection module and a video processing module. The timing detection module is configured to receive an unknown video information stream. The video processing module, however, may not be able to process the video information stream without knowing characteristic information regarding the video information stream. The timing detection module is configured to use several modules to determine characteristic information about the video information stream. The timing detection module is configured to store the characteristic information in a register coupled to the video processing module. The video processing module is configured to receive the video information stream, to retrieve the characteristic information, and to process the video information stream using the characteristic information. The timing detection module is configured to repeatedly analyze the video information stream to determine if the characteristic information should be updated. Other embodiments are within the scope of the invention.

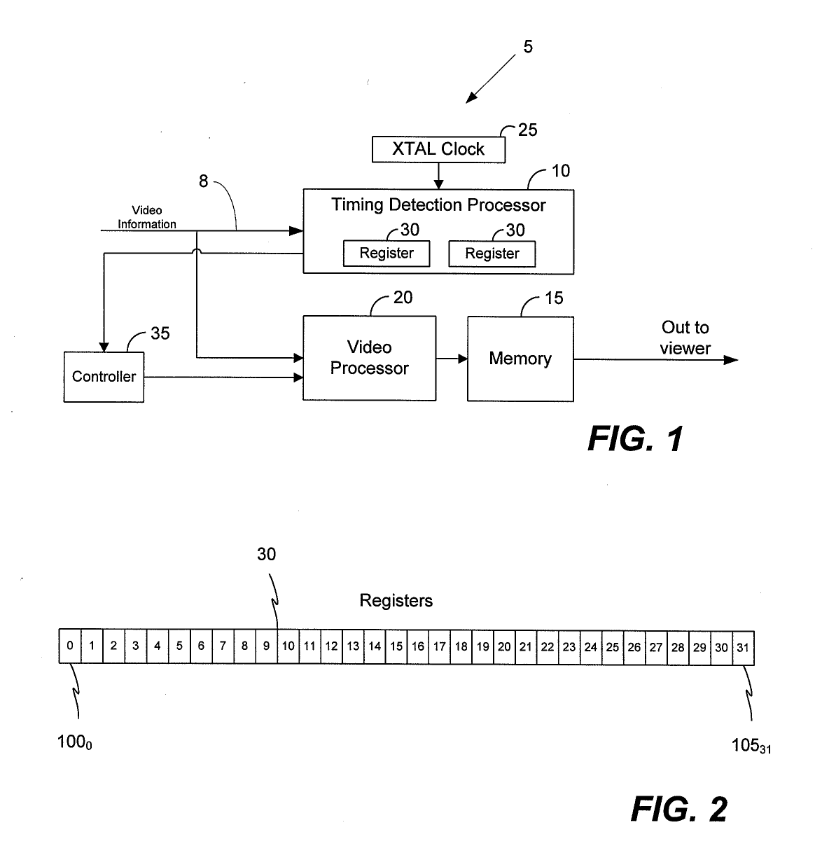

Referring to FIG. 1, a video display system 5 includes a timing detection processor 10, a memory 15, a video processor 20, a clock 25, and a controller 35. The timing detection processor 10 and the video processor 20 are multipurpose microprocessors such as digital signal processing units. The processor 10 includes registers 30. Here two registers 30 are shown although other quantities of registers can be used. The video display system 5 can be, e.g., within a television, a cable box, a video game console, a computer (e.g., a notebook computer, a desktop computer, a personal digital assistant (PDA), mobile handset, etc). The memory 15 is, for example, RAM. The timing detection processor 10 is configured to receive a video information stream from a source (e.g., a cable service provider, a DVD player, a graphics processing unit, etc.) via an input 8 and to store one or more signals in the registers 30. Signals stored by the timing detection processor 10 in the registers 30 include “active” information (e.g., picture information) and characteristic information (e.g., information about the characteristics of the active information). The controller 35 is configured to read the information stored in the registers 30 and to provide the information to the video processor 20 (e.g., the controller 35 can program the video processor 20 using the information stored in the registers 30). The video processor 20 is configured to perform digital signal processing on the active information using at least a portion of the characteristic information provided by the controller 35. The video processor 20 can be configured to perform various types of signal processing such as scaling, resampling, video capture, color correction, etc. The video signal processor 20 is configured to store processed video information in the memory 15. The memory 15 is configured such that a video device (e.g., a television) can retrieve the processed information for use (e.g., display on the television). While FIG. 1 shows a single timing detection processor 10, a single memory 15, and a single video processor 20, other quantities of these devices are possible (e.g., to receive and process multiple unknown video information streams).

The system 5 is configured to receive a video information stream having unknown characteristics, to determine characteristics about the video information, and to process the video information using the determined characteristics. For example, in order to process the video information stream, the video processor 20 uses characteristic information corresponding to incoming video information. Without the characteristic information, the video processor 20 may have difficulty processing and/or displaying the video information (e.g., corrupted images and/or no images can result). Each time a new video signal is detected at the input 8, the timing detection processor 10 is configured to determine characteristics of the video stream and store characteristic information regarding these characteristics in the registers 30. Thus, the system 5 is configured to convert an unknown signal into a known signal by determining the characteristic information and using this information to process the video information. The video processor 20 is configured to receive the characteristic information from the controller 35 and to process the video information using the characteristic information. The controller 35 can be configured to provide all or a portion of the information stored in the registers 30, if desired.

The timing detection module 10 is configured to provide an indication that some or all of the characteristic information is ready to be used by the video processor 20 (e.g., through the controller 35 or via a direct connection to the video processor 20). For example, if portions of the characteristics are verified (e.g., have become stable) the timing detection processor 10 can set respective flags in the memory 15 thereby indicating that the corresponding characteristics are ready to be provided to the video processor 20. The timing detection processor 10 is further configured to set an additional flag if all of the relevant characteristics are ready to be used by the video processor 20. The timing detection processor 10 is configured such that if all “ready to read” flags are set and a portion of the characteristic information becomes unstable, then the timing detection processor 10 can cancel the flag indicating that the corresponding information is ready to be read.

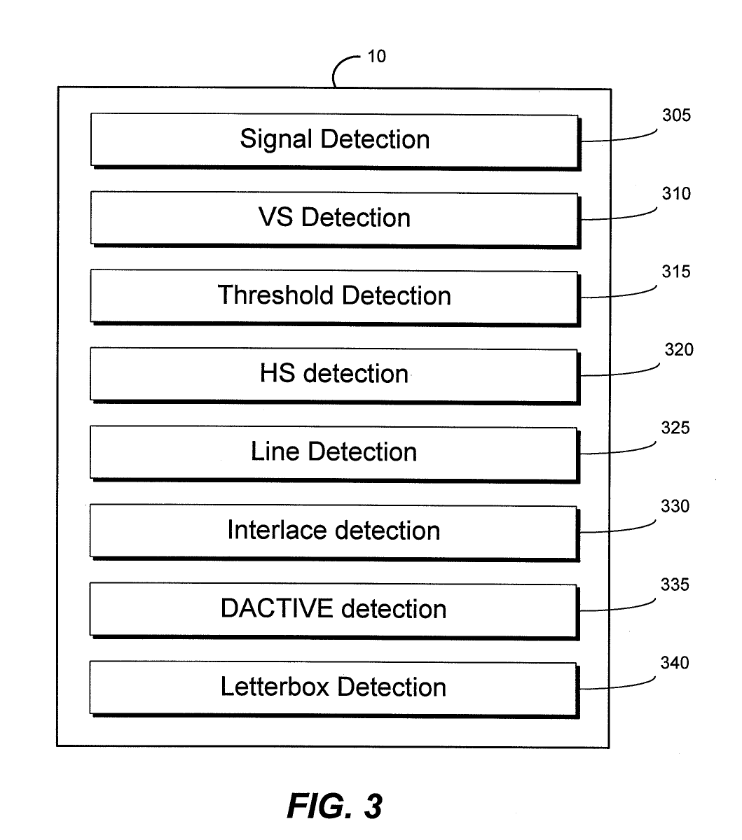

The characteristic information stored by the timing detection processor 10 in the registers 30 can include single bit pieces of information and/or multi-bit pieces of information. Referring also to FIG. 2, an exemplary one of the registers 30 includes bit positions 105₀ through 105₃₁. The timing detection processor 10 is configured to store information in one or more of the bit positions 105 corresponding to the quantity of bits making up the piece of information. For example, a ready to read indicator that is, e.g., one bit, can be stored in a single one of the bit positions 105. Likewise, a Letterbox Start Position indicator that is, e.g., eight bits, can be stored in eight consecutive bit positions 105. Alternatively, multi-bit pieces of information can be stored in non-consecutive ones of the bit positions 105, or across multiple registers 30. An exemplary bit-wise configuration of the registers 30 is attached hereto as Appendix A. Other configurations of the registers 30 are possible, including quantities of other registers 30 and more or fewer than thirty-two bit positions.

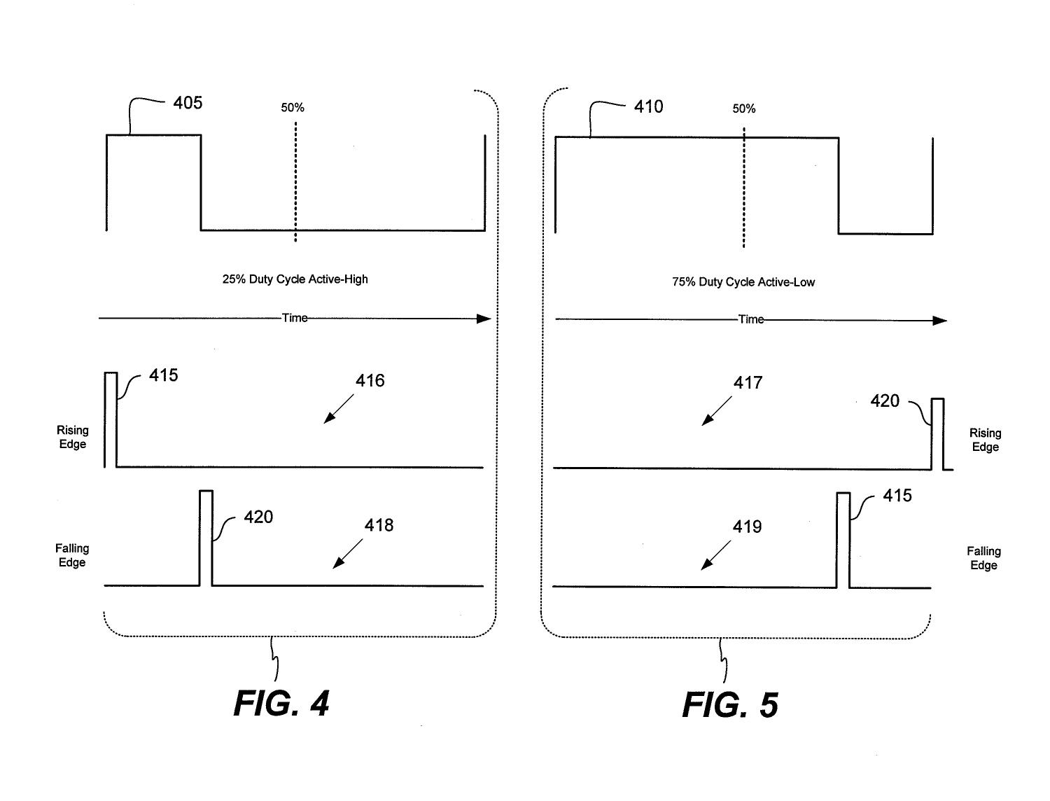

Referring to FIGS. 1 and 3, the system 5 includes modules (e.g., applications) that include computer readable instructions that, when executed, are configured to cause the timing detection processor 10 to provide various functions. The timing detection processor 10 includes a signal detection module 305, a VS detection module 310, a threshold detection module 315, an HS detection module 320, a line detection module 325, an interlace detection module 330, a DACTIVE detection module 335, and a letterbox detection module 340. While the system 5 has been described as including the computer readable instructions, the instructions can reside elsewhere (e.g., on a server). The functions can be implemented, e.g., using software code, FPGAs, ASICs, etc.

### Signal Detection Module

The signal detection module 305 is configured to detect the presence of an incoming signal by detecting the presence HS signals and VS signals contained within an HS signal stream and a VS signal stream, respectively. The signal detection module 305 includes a HS signal watchdog timer and a VS signal watchdog timer that that are each configured to operate at 27 MHz, although other clock frequencies are possible. The HS and VS signal watchdog timers are configured to timeout at 0×7FFFFF and 0×3FFF, respectively, if no HS signals or VS signals are detected (e.g., the counters count from 0×0 to the respective limits). The HS watchdog timer is configured to set a flag in the memory 15 if no suitable HS signal is detected prior to timing-out. Likewise, the VS watchdog timer is configured to set a flag in the memory 15 if no suitable VS signal is detected prior to timing-out. Using the above parameters (i.e., 27 MHz and 0×7FFFFF), if no suitable HS signal is detected within about 0.3 s, the HS watchdog timer will timeout and set the corresponding flag. Likewise, using the above parameters (i.e., 27 MHz and 0×3FFF), if no suitable VS signal is detected within about 0.6 ms, the VS watchdog timer will timeout and set a corresponding flag. The lack of timeout by the HS and VS watchdog timers indicates the presence of an HS signal and a VS signal, respectively. Once a timeout flag is set, the HS and VS watchdog timers are configured to count upwards from 0×0 again, and are configured to clear the timeout flag if a signal is detected.

The HS and the VS watchdog timers are configured not to timeout if a series of consecutive HS signals and VS signals are received within a specific amount of time. The HS watchdog timer is configured to detect 128 consecutive valid HSs. The HS watchdog timer is configured such that if 128 consecutive valid HSs are detected, the HS watchdog timer (and corresponding flag) is reset, thereby avoiding a timeout by the HS watchdog timer (and thus avoiding the corresponding flag). Likewise, the VS watchdog timer is configured to detect three consecutive valid VSs. The VS watchdog timer is configured such that if three consecutive valid VSs are detected, the VS watchdog timer (and corresponding flag) is reset, thereby avoiding a timeout by the VS watchdog timer. For example, so long as a valid signal is present (including HS signals and VS signals) the HS and VS watchdog timers will continuously be reset, thereby avoiding a timeout.

The signal detection module 305 is further configured to set additional flags and/or store additional characteristic information in response to predetermined events occurring. For example, the signal detection module 305 is configured such that if neither of the HS and VS watchdog timers have timed out, a flag can be set indicating that a valid signal is being received. The signal detection module 305 can be configured such that the valid signal flag is set by default, but a timeout by either or both of the HS and VS watchdog timers can cancel the valid signal flag. The signal detection module 305 is further configured to detect (as a function of how quickly the HS and VS watchdog timers are reset) a change in the vertical refresh rate and a change in the horizontal refresh rate.

The HS and VS watchdog timers can operate at different clock speeds, and be configured to timeout at different intervals than those described above. For example, the VS watchdog timer can be configured to operate at 50 MHz and timeout at a value of 0×1000000.

### VS Detection Module

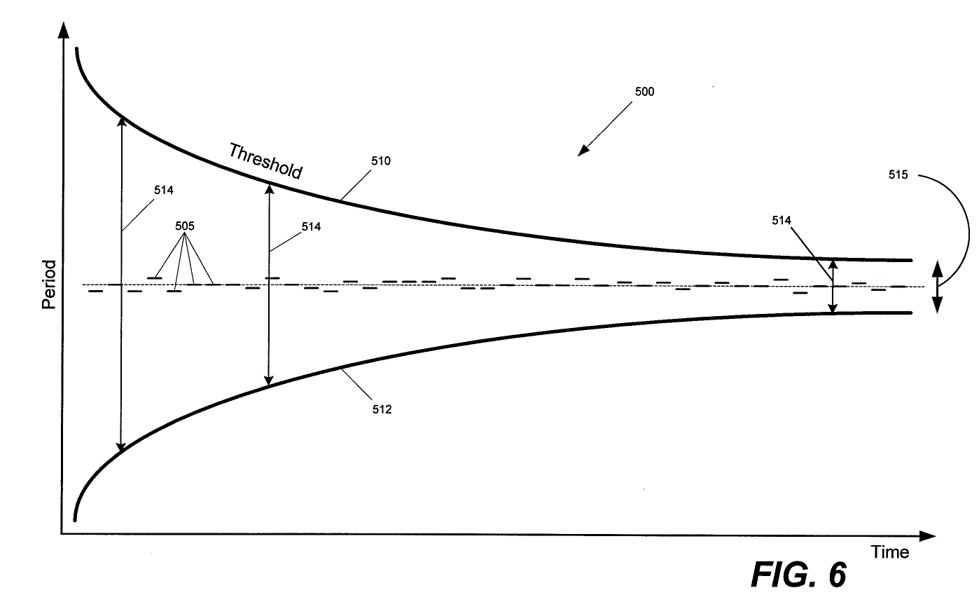

The VS detection module 310 is configured to detect the polarity of an incoming VS signal stream. The VS detection module 310 can be configured to begin operation if a valid video information stream has been detected by the signal detection module 305. Referring also to FIGS. 4-5, the polarity of the VS signals can vary between, e.g., a 25% duty cycle active-high (e.g., a waveform 405) and a 75% duty cycle active-low (e.g., a waveform 410). The VS detection module 310 is configured to determine which polarity is used by measuring the duty cycle of the VS signals. The VS detection module 310 is configured to set a flag in the registers 30 indicating an active-high polarity if the duty cycle is less than 50% and to set a flag in the registers 30 indicating an active-low polarity if the duty cycle is greater than 50%. The VS detection module 310 is configured to calculate the polarity of the VS signal stream using several consecutive VS signals. For example, the VS detection module 310 can calculate the polarity of the VS signal stream using between eight and sixteen consecutive VS signals. If between eight and sixteen consecutive VS signals are calculated as having similar duty cycles, then the VS detection module 310 can indicate that that the polarity has been calculated (e.g., by setting the corresponding flag) and will set a flag indicating the polarity used by the video information stream.

The VS detection module 310 is configured to determine the location of the active edges in the VS signal stream. The VS detection module 310 is configured to determine edge locations corresponding to the VS signals. The VS detection module 310 is configured to combine the polarity information and the edge location information to determine the location of rising edges (as indicated by signals 415 in a rising-edge-indicating signal 416 and a falling-edge-indicating signal 419) and falling edges (as indicated by signals 420 in a rising-edge-indicating signal 417 and a falling-edge-indicating signal 418). The VS detection module 310 is configured to determine which edges are “active” edges and “deactive” edges by combining the polarity information, the edge location information, and the rising/falling edge information. The VS detection module 310 is configured to set flags in the registers 30 indicating the corresponding calculated values.

Using the above calculated information, the VS detection module 310 can determine a period corresponding to the VS signal stream. The VS detection module 310 is configured to calculate the period of the VS signal stream by analyzing the frequency at which active edges occur. The VS detection module 310 is configured to store information indicative of VS signal period in the registers 30. Furthermore, the VS detection module 310 is configured to compute the average period of a VS signal, e.g., using eight VS signal period measurements.

### Threshold Detection Module

The threshold detection module 315 is configured to track the period of the VS signals contained in the VS signal stream and to provide an indication of how reliable/constant the average period is from one VS signal to the next. As described above, for each VS signal received by the VS detection module 310, the VS detection module 310 can calculate the average period e.g., over the prior eight VS signals. The threshold detection module 315 is configured to compare the average values to a variable threshold to calculate an indication of the stability of the VS signal.

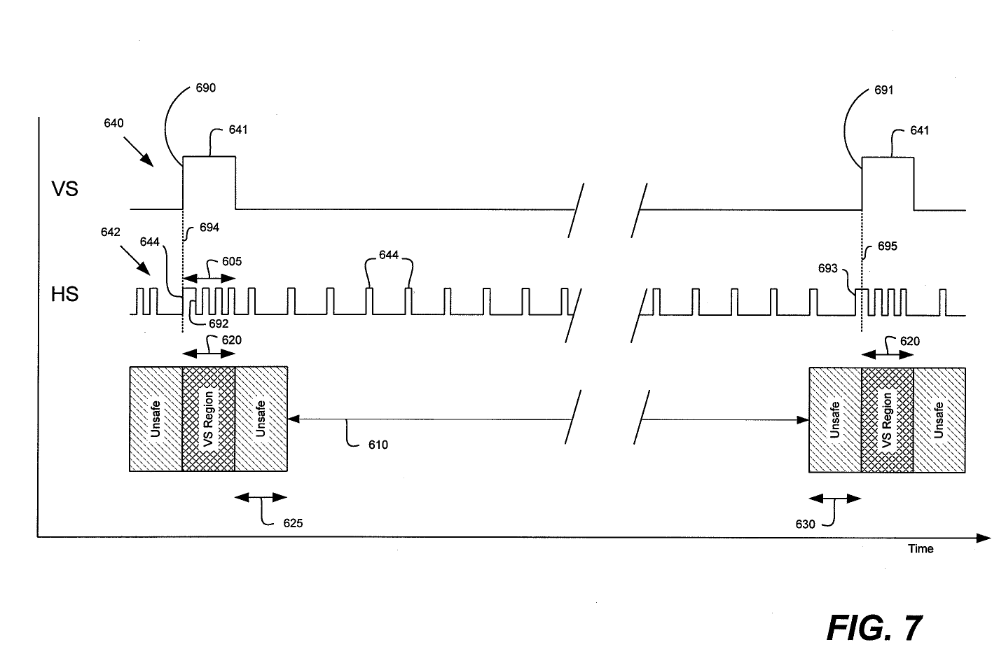

Referring to FIG. 6, with further reference to FIG. 3, a graph 500 includes data points 505, thresholds 510, 512, and an error margin 515. Each of the data points 505 corresponds to an average VS period value calculated by the VS detection module 310. The threshold detection module 315 is configured to receive average VS period values 505 from the VS detection module 310 and to compare the data points 505 to the thresholds 510, 512. The threshold detection module 315 is configured such that for a new signal (as judged by signal detection module 305), the thresholds 510, 512 are set to provide a large threshold range by 514 that becomes smaller as time progresses (e.g., the threshold 510 ramps-down and the threshold 512 ramps up). For example, the threshold range 514 on the left side of the graph 500 is larger than the threshold range 514 on the right side of the graph 500. The threshold detection module 315 is configured to repeatedly decrease (e.g., tighten) the threshold range 514 as additional data points 505 are received. The threshold detection module 315 is configured to repeatedly decrease the threshold range 514 until the data points 505 violate (fall outside of) the threshold range 514. In response to the data points 505 violating the threshold range 514, the threshold detection module 315 is configured to increase the threshold range 514 slightly, e.g., until the violations stop. The final value of the thresholds 512, 514 define the error margin 515. The threshold detection module 315 is configured to set flags including, e.g., a value indicative of the error margin 515 and whether each additional data point 505 received by the threshold detection module 315 violates the error window 515. The threshold detection module 315 can also be configured to provide an indication of the frequency at which newly arrived data points 505 violate the error range 515.

### HS Detection Module

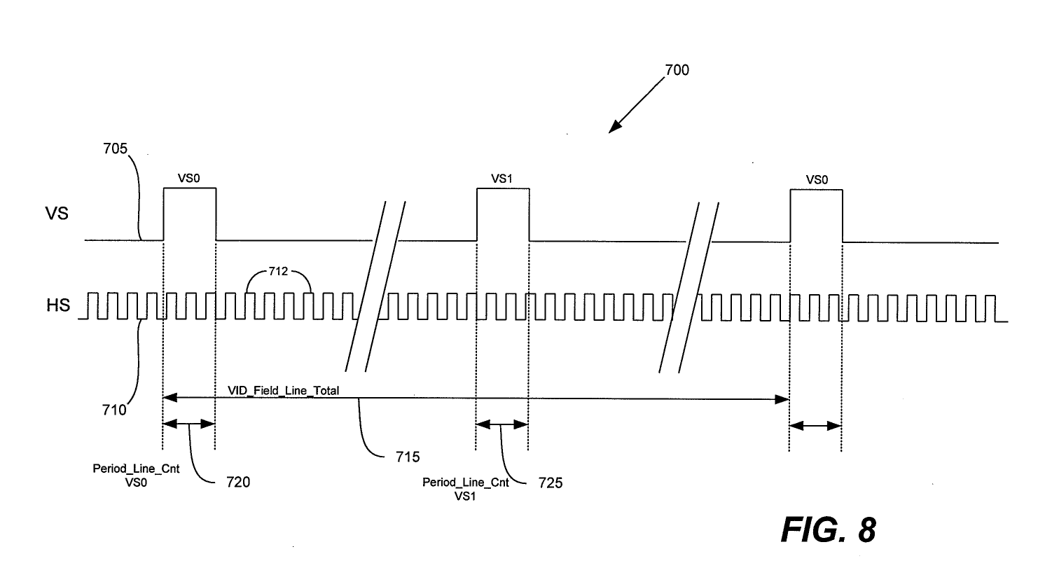

The HS detection module 320 is configured to detect the presence, polarity, duty cycle, and period of HS signals in the HS signal stream. In contrast to the VS signals described above, HS signals can be less constant and more unstable at times. Referring to FIGS. 3 and 7, HS signals can vary and/or become unstable depending on proximity to a VS signal 641 in a VS signal stream 640. The HS signals 644 are regular/stable during a safe interval 610 when there is no VS signal 641, but is unstable in an interval 605 when there is a VS signal 641. The HS detection module 320 is configured to detect the presence, polarity, and/or duty cycle of HS signals 642 during the portion of the incoming video stream corresponding to active video information (e.g., because of the instability of the HS signal stream 642 at other times). The HS detection module 320 is configured to detect the HS signal stream 642 (and corresponding characteristic information) by analyzing a series of the HS signals 644 and using the threshold detection module 315.

The HS detection module 320 is configured to ignore a portion of the HS signal stream 642 when determining the presence, polarity, duty cycle, and period of HS signals 644. For example, the HS detection module 320 is configured to ignore the HS signals 644 occurring during the same time as a VS signal 641 (e.g., an interval 620). The HS detection module 320 is further configured to ignore HS signals 644 occurring during unsafe intervals near the interval 620 including a pseudo back porch 625 and a pseudo front porch 630. The HS detection module 320 is configured to begin with a known value for the back porch 625, and a known number of HS signals 644 to obtain. The combination of i) the known starting value for the back porch 625 and ii) the known starting value of HS signal samples 644 to obtain can be used to define the size of the front porch 630. For example, if there are 100 ms between adjacent VS signals, the back porch is 5 ms, and forty HS signals 644 are obtained (at 2 ms intervals), then the front porch 630 is about 15 ms.

The HS detection module 320 is configured to determine the polarity, duty cycle, and period of the HS signals 644 by starting with a large value for the back porch 625 and a small number of samples to obtain. For example, the HS detection module 320 is configured to calculate the polarity, duty-cycle, active edges, and/or period of, e.g., eight of the HS signals 644 using techniques similar to that described above with respect to the VS detection module 310. Increasing the number of samples used to calculate the HS signal characteristic information can increase the quality of the resulting values. The HS detection module 320 is configured to calculate the size of the back porch 625 and the number of the HS signals 644 to obtain by gradually decreasing the size of the back porch 625 and increasing the quantity of samples 644 to obtain until an operational back porch and an operational number of samples 644 to obtain is calculated. The HS detection module 320 is configured calculate the operational back porch and operational number of samples 644 to obtain by gradually decreasing the size of the back porch 625 and increasing the number of samples 644 to obtain, respectively, until the threshold detection module 315 indicates that the error margin 515 has been violated (e.g., as defined by the threshold detection module 315). For example, if the HS detection module 320 is analyzing HS synch signals 644 in the safe region 610 and continues into the interval 620, the period of the measured HS signals 644 (corresponding to the interval 620) will likely have a period differing from the period of the HS signals 644 measured during the safe region 610 (thereby violating the error margin 515 in the threshold detection module 315). The HS detection module 320 is configured to determine the safe region 610 by combining the operational back porch 625 and the operational number of samples to obtain. The HS detection module 320 is configured to set flags indicating the size of the interval 605, the size of the safe region 610, the size of the operational back porch 625, the operational number of samples 644 to obtain, and the size of the front porch 630.

### Line Detection Module

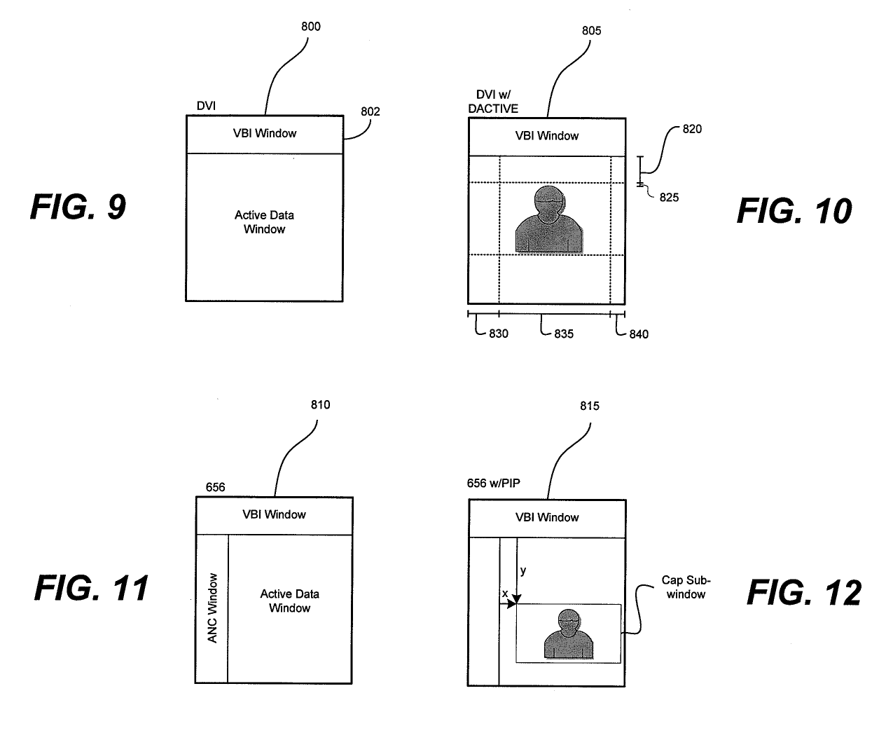

The line detection module 325 is configured to determine information about a quantity of lines in each field in the video information stream and a quantity of lines corresponding to a time when the VS signal stream 640 is active. The line detection module 325 is configured to use the characteristic information provided by the signal detection module 305, the VS detection module 310, threshold detection module 315, and the HS detection module 320 to calculate the respective quantities. Referring also to FIG. 8, a graph 700 includes a VS signal stream 705 and a HS signal stream 710. The line detection module 325 is configured to count the number of HS signals 712 over two adjacent fields, e.g., corresponding to an interval 715 (as the number of lines in a single field can vary due to interlacing). The line detection module 325 is further configured to count the number of HS signals 712 occurring when the VS signal is active (e.g., corresponding to the combination of intervals 720 and 725).

### Interlace Detection Module

Referring to FIGS. 1 and 3, the interlace detection module 330 is configured to determine if the video information stream includes interlaced (e.g., even and odd fields) or progressive video information. The interlace detection module 330 is configured to estimate whether a specific field is an even or odd field by comparing the HS signals and VS signals. The interlace detection module 330 is configured to analyze the relationship between edges of the VS signals and corresponding HS signals. For example, referring to FIG. 7, the interlace detection module 330 is configured to compare an active edge 690 of a VS signal with an active edge 692 of an HS signal (e.g., at a line 694) and to compare an active edge 691 of a VS signal with an active edge 693 of an HS signal (e.g., at a line 695). The interlace detection module 330 is configured to estimate that the field corresponding to a given VS signal is an even field if the active edges are aligned (e.g., the line 694) and to estimate that the field corresponding to a given VS signal is an odd field if the VS active edge is misaligned from the active edge of the corresponding HS signal (e.g., at the line 695). While the interlace detection module 330 has been described as the module responsible for estimating whether a field is even or odd, other modules can be configured to perform the estimation process.

The interlace detection module 330 is further configured to examine four VS and HS signal comparisons. The interlace detection module 330 is configured to set a flag indicating that the video information stream includes progressive video information if all four (or another desired threshold or criterion) of the VS/HS signal comparisons are equal (e.g., all of the VS signal active edges align with HS signal active edges). Otherwise, the interlace detection module 330 sets a flag indicating that the video information stream includes interlaced video information.

### DACTIVE Detection Module

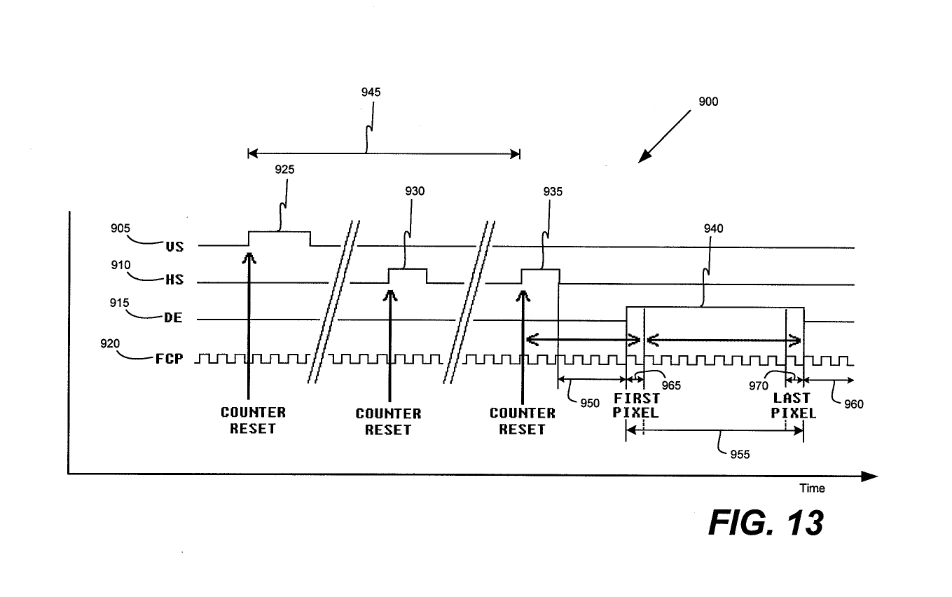

In some versions of the video information stream, the active video information contained within the stream does not occupy the entire visible area of a window. Referring also to FIGS. 9-12, windows 800 and 805 correspond to DVI digital video information streams, and windows 810 and 815 correspond to BT.656 video information streams. Only a portion of each of the windows 800, 805, 810, and 815 are used to provide an image to a viewer. The portions of the windows 800, 805, 810, and 815 that include image information correspond to the DACTIVE region. For example, in the window 800, a vertical blanking interval (VBI) 802 window typically does not contain information displayed to the viewer, and thus is not part of the DACTIVE region.

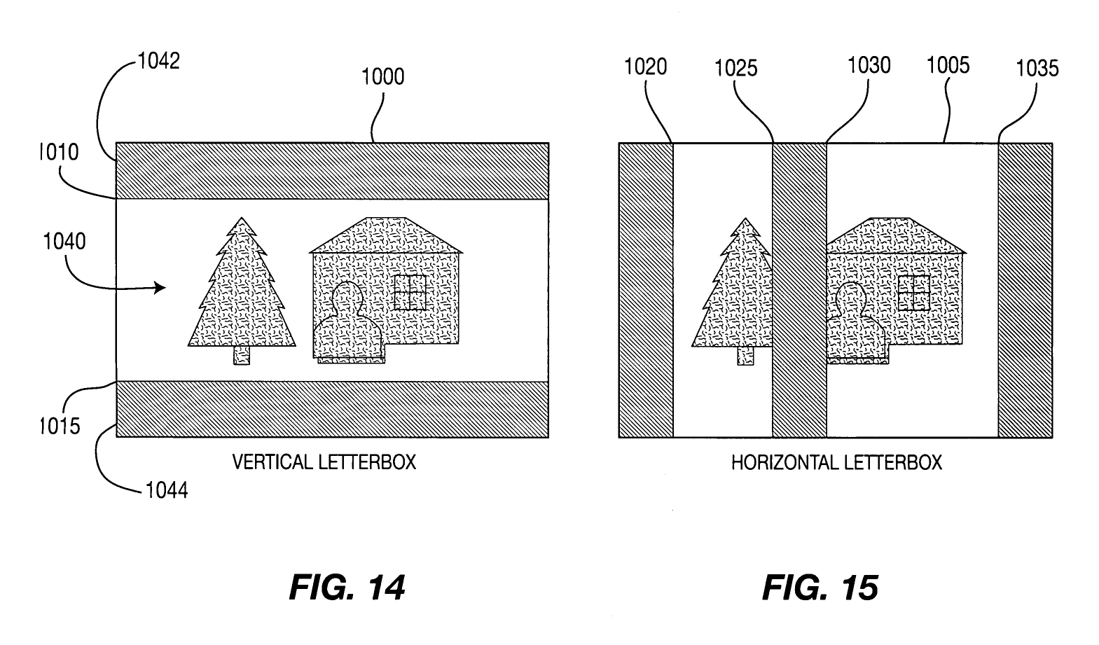

Referring also to FIG. 13, a portion 900 of the video information stream includes a VS signal stream 905, an HS signal stream 910, a DACTIVE signal stream 915, and a pixel clock stream 920. The video information stream 900 is configured such that each time the video information stream 900 includes information that will be displayed in the active region of at least one of the windows 800, 805, 810, 815, the DACTIVE signal 915 becomes active. For example, a VS signal 925 indicates the start of a new field in the video information stream, and HS signals 930 and 935 indicate the starts of new horizontal lines. An interval 945 corresponds to a portion 820 of the window 805 (e.g., there is no DACTIVE signal during the interval 945). Likewise, the HS signal 935 indicates the beginning of a horizontal line 825 in the window 805. In the window 805, however, even though the line 825 contains DACTIVE information, a portion 830 of the line 825 does not contain DACTIVE information. Thus, the portion 830 of the line 825 corresponds to an interval 950 in the information stream 900. A portion 835 of the line 825 (which includes DACTIVE information) corresponds to an interval 955 of the information stream 900. A portion 840 of the line 825 (which contains no displayed information) corresponds to an interval 960 of the video information stream 900.

The DACTIVE detection module 335 is configured to determine the portion of the video information stream where active data is expected. The DACTIVE detection module 335 is configured to detect a first and a last pixel from each of the horizontal lines in each of the frames (e.g., a frame includes two fields if interlaced, one field if progressive). For example, the DACTIVE detection module 335 is configured to determine pixel locations 965 and 970, corresponding to first and last pixels, respectively, of the line 825 of the window 805. The DACTIVE detection module 335 is configured to store information indicative of the pixel locations 965 and 970 in the registers 30. The DACTIVE detection module 335 is also configured to determine the first and last pixel location of other DACTIVE lines contained in the video information stream. The DACTIVE detection module 335 is configured to determine the first horizontal line (e.g., in a field) that includes a DACTIVE signal and to determine the last horizontal line (e.g., in a field) that includes a DACTIVE signal. The DACTIVE detection module 335 is configured to set flags in the registers 30 indicative of the calculated characteristic information.

### Letterbox Detection Module

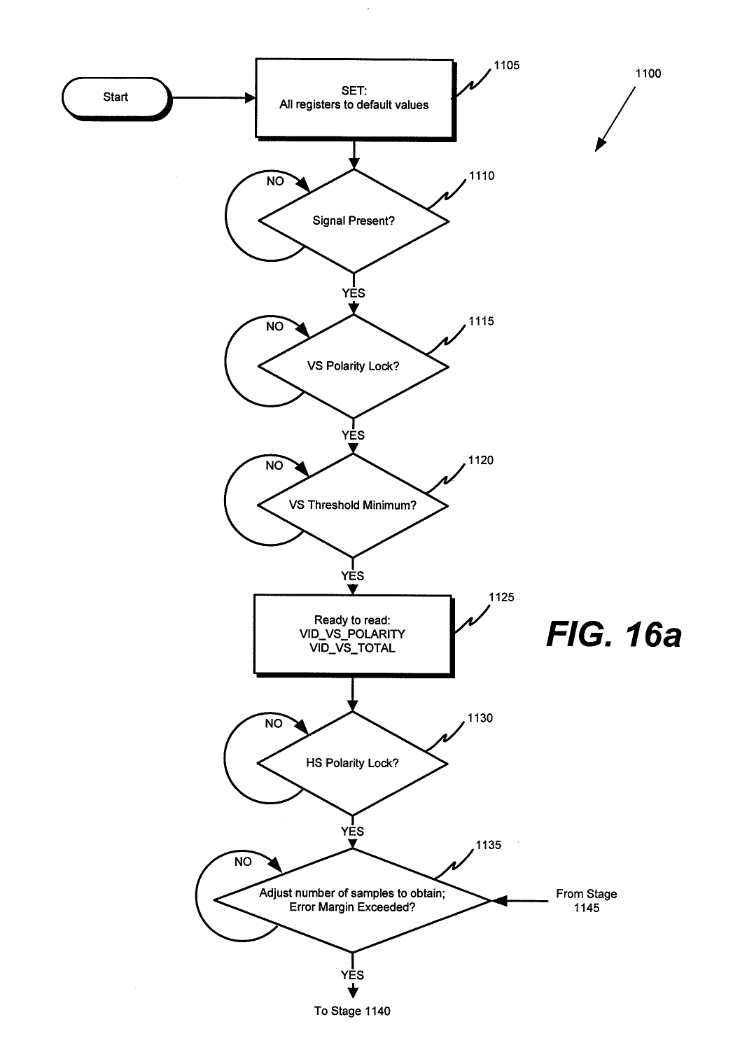

Referring to FIGS. 1, 3, and 14-15, windows 1000 and 1005 include letterboxed images. The window 1000 includes an active start 1010 and an active end 1015. The window 1005 includes window starts 1020 and 1030 and window ends 1025 and 1035. The letterbox detection module 340 is configured to determine the position of the active start 1010, the active end 1015, the window starts 1020 and 1030, and the window ends 1025 and 1035. Letterboxing, while in appearance can be similar to the window regions discussed above with respect to the DACTIVE module 335, is accomplished in a different manner. Letterboxing uses DACTIVE information to make a video image appear to take up less than the entire active window. For example, the letterboxed image 1040 in the window 1000 includes top and bottom black bars. Unlike as discussed above, black bars 1042, 1044 are caused by DACTIVE information that is made up of all black pixels. While the window 1005 shows two window starting points, more or fewer window starting points are possible.

The letterbox detection module 340 is configured to determine the position of the active start 1010 and the active end 1015. The letterbox detection module 340 is configured to identify the first horizontal line that is non-black (e.g., the active start 1010) and to identify the last horizontal line that is non-black (e.g., the active end 1015). The letterbox detection module 340 is configured to determine if a horizontal line is non-black by comparing it to a known black threshold on a color component, per-pixel basis. For example, a threshold for an RGB signal includes a red threshold level, a green threshold level, and a blue threshold level. The letterbox detection module 340 is configured to compare each color component of each pixel of each horizontal line to thresholds (which may or may not be equal). The letterbox detection module 340 is configured such that if all of the color components making up a pixel are below their respective thresholds, the pixel is considered a “black pixel.” The letterbox detection module 340 is configured such that if the number of black pixels in each horizontal line is above a threshold (e.g., 75%) then the horizontal line is considered a black line. The letterbox detection module 340 is configured to store information corresponding to the position of the active start 1010 and the active end 1015 in the registers 30.

The letterbox detection module 340 is configured to determine the position of the window starts 1020 and 1030 and the window ends 1025 and 1035. As described above, the letterbox detection module 340 is configured to determine if each pixel of each horizontal line is a black pixel or a non-black pixel. To determine the starts 1020, 1030, the letterbox detection module 340 is further configured to count the number of consecutive non-black pixels in each horizontal line (beginning from, e.g., the left side of the picture), or determine a percentage of non-black pixels over a quantity (e.g., 20) of pixels. If the number of consecutive non-black pixels in a horizontal line exceeds a non-black-line threshold (e.g., N consecutive pixels or Y% (e.g., 90%) of M consecutive pixels), then the letterbox detection module 340 is configured to determine the start position of the window (e.g., the window start 1020). The letterbox detection module 340 is configured to determine the actual starting pixel (e.g., the first non-black pixel) by determining the pixel where the non-black-line threshold (comprising the color thresholds) is exceeded, and subtracting a quantity of pixels about equal to the threshold number (N) of consecutive pixels or the number (Y) of pixels used to determine the percent of non-black pixels (e.g., if the threshold is N pixels, if the threshold is exceeded, the window start began N pixels prior to the pixel that caused the threshold to be exceeded). Likewise, the letterbox detection module 340 is configured to determine the ends 1025, 1035 by comparing black pixels (e.g., consecutive black pixels or percent of consecutive pixels) to a threshold.

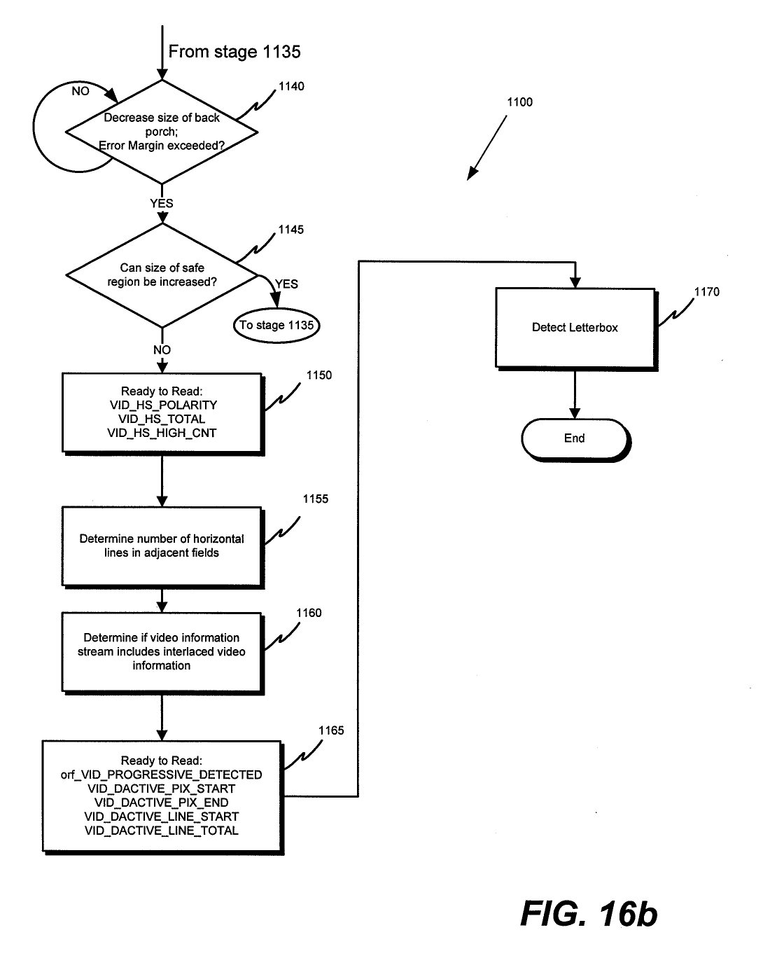

In operation, referring to FIGS. 16A-16B, with further reference to FIGS. 1-5, a process 1100 for determining characteristic information about an incoming video information stream using the system 5 includes the stages shown. The process 1100, however, is exemplary only and not limiting. The process 1100 may be altered, e.g., by having stages added, removed, rearranged, combined, and/or executed concurrently. Furthermore, some of the stages described below can be omitted, if desired (e.g., if the calculated information is not desired). The system 5 execute part or all of the process 1100 at various times. For example, the system 5 can execute the process 1100 each time a display is turned-on, and/or by request of a user, periodically or continuously.

At stage 1105, the system 5 sets the registers 30 to the default values (e.g., as indicated in Appendix A). The system 5 uses default information from an external source and/or values previously stored in the registers 30.

At stage 1110, the system 5 determines if a video information stream is present at the input of the timing detection processor 10 using the signal detection module 305. The signal detection module 305 uses the VS and HS watchdog timers to determine the presence of valid VS and HS signals, respectively. The VS watchdog timer begins counting upwards from 0×0 and counts until either three consecutive valid VS signals are received, or the VS watchdog timer times out (e.g., upon reaching 0×7FFFFF). If the VS watchdog timer times out, the signal detection module 305 sets a flag indicating that no VS signal is being received. As long as VS signals are received, the VS watchdog timer avoids timing out (e.g., the watchdog timer is repeatedly reset). Likewise, the HS watchdog timer begins counting upwards from 0×0 and counts until either 128 consecutive valid HS signals are received, or the HS watchdog timer times out (e.g., upon reaching 0×3FFF). If the HS watchdog timer times out, the signal detection module 305 sets a flag indicating that no HS signal is being received. As long as HS signals are received, the HS watchdog timer avoids timing out. The signal detection module 305 sets a flag in the registers 30 if a valid video information signal is being received by the timing detection module (e.g., if neither of the VS or HS timeout flags are set). If no valid signal is received by the timing detection module 5, the process remains in stage 1110. If a valid signal is present, the process 1100 proceeds to stage 1115.

At stage 1115, the VS detection module 310 determines the polarity of the incoming VS signal stream using the VS detection module 310. The VS detection module determines the duty cycle of at least eight consecutive VS signals. If the duty cycle of eight consecutive VS signals is less than 50%, the VS detection module 310 sets a flag indicating that the polarity of the VS signal stream is active-high. If the duty cycle of the eight consecutive VS signals is greater than 50%, the VS detection module 310 sets a flag indicating that the polarity of the VS signal stream is active-low. If the VS detection module 310 cannot determine the polarity of an incoming VS signal stream, the process 1100 remains in stage 1115, otherwise the process 1100 proceeds to stage 1120. If the VS detection module 310 cannot determine the polarity of the incoming VS signal stream, then the process preferably remains at stage 1115, although other configurations are possible (e.g., the process 1100 proceeds to another stage after N loops of stage 1115).

At stage 1120, the threshold detection module 315 analyzes the VS signal stream received by the timing detection module 10. The threshold detection module 315 indicates if the average period (e.g., of the last eight received VS signals) violates a the error margin 515. The threshold detection module 315 begins analyzing the average period of the VS signals using a large threshold range 514 and gradually ramps-down the threshold range 514 until consecutive violations occur. The threshold detection module 315 backs off (e.g., enlarges) the threshold range 514 slightly until an acceptable number of violations occur (e.g., another threshold corresponding to one violation for every one thousand samples). The threshold detection module 315 sets a flag indicating that the threshold has been stabilized, and a flag indicating the size of the error margin 515. If the threshold is not stabilized, the process 1100 remains in stage 1120, otherwise the process 1100 proceeds to stage 1125. The “minimum threshold” can be adjusted avoid the process 1100 from remaining in stage 1125 indefinitely.

At stage 1125, the information calculated during the stages 1110, 1115, and 1120 are ready to be read by the video processor 20, if desired.

At stage 1130, the HS detection module 320 determines the polarity of the incoming HS signal stream 642. The HS detection module 320 analyzes the HS signals 644 corresponding to periods in time where no VS signal 641 is present in the video information stream (e.g., because the presence of a VS signal 641 can affect the stability of HS signals 644). The HS detection module 320 determines the polarity of the HS signals 644 by analyzing HS signals 644 in the safe region 610. If the HS detection module 320 cannot successfully determine the polarity of the HS signal stream 642, the process 1100 remains in stage 1130, otherwise the process 1100 proceeds to stage 1140.

At stage 1135, the HS detection module 320 maintains the back porch 625 at a constant level and gradually increases the number of samples 644 to obtain until the safe region 610 extends into the VS region 620. For example, once the timing detection module 10 locks on to the HS signal stream 642 during stage 1130, the average period of the HS signals 644 (e.g., over the prior eight HS signals 644) is provided to the threshold detection block 315 (which determines the operational threshold corresponding to the HS signal stream 642 observed during the stage 1130 and provides an indication of whether the error margin 515 has been violated). The HS detection module 320 increases the number of samples 644 to obtain until the threshold detection module 315 indicates that the error margin 515 is violated (e.g., the period of the HS samples 644 begins to vary because the HS samples 644 are obtained in the VS region 620). With the error margin 515 has been violated, the HS detection module 320 reduces, by a predetermined number, the number of samples 644 to obtain, thereby establishing the front porch 630. With the front porch 630 has been established, the process 1100 proceeds to stage 1140.

At stage 1140, the HS detection module 320 maintains the front porch 630 and the number of samples 644 to obtain at a constant level and gradually decreases the size of the back porch 625 until the safe region 610 extends into, the VS region 620. For example, once the timing detection module 10 locks on to the HS signal stream 642 during stage 1130 and stage 1135, the average period of the HS signals 644 (e.g., over the prior eight HS signals 644) is provided to the threshold detection block 315 (which determines the operational threshold corresponding to the HS signal stream 642 observed during stage 1130 and provides an indication of whether the error margin 515 has been violated). The HS detection module 320 decreases the size of the back porch 625 until the threshold detection module 315 indicates that the error margin 515 is violated (e.g., with the period of the HS samples 644 varying because the HS samples 644 are obtained in the VS region 620). With the error margin 515 violated, the HS detection module 320 reduces, by a predetermined amount, the size of the back porch 625. With the HS detection module 320 determining the size of the back porch 625, the process 1100 proceeds to stage 1145.

At stage 1145, the HS detection module 320 determines if the safe region 610 can be made larger without extending too close to the VS region 620. If the safe region 610 can be extended, the process 1100 proceeds to stage 1135, otherwise the process 1100 proceeds to stage 1150.

At stage 1150, the timing detection module 10 sets a flag indicating that the flags set during stages 1130, 1135, 1140, and 1145 are ready to be read by the video processor 20, if desired.

At stage 1155, the line detection module 325 determines the number of horizontal lines corresponding to sub-sets of fields of the video information stream. The line detection module 325 determines the quantity of horizontal lines in adjacent fields (e.g., the interval 715), and sets a flag accordingly. The line detection module 325 also determines the quantity of horizontal lines occurring in the video information stream when the VS signal is active (e.g., during an interval 720), and sets a flag accordingly.

At stage 1160, the interlace detection module 330 determines if the video information stream contains interlaced or progressive video information. The interlace detection module 330 determines if the video information stream includes interlaced or progressive video information by analyzing the quantity of lines in each of four consecutive fields of the video information stream. If the number of lines in each of the four consecutive fields is equal, then the interlace detection module 330 sets a flag indicating that the video information stream includes progressive video information, otherwise the interlace detection module sets a flag indicating that the video information stream includes interlaced video information.

At stage 1165, the DACTIVE detection module 335 determines the portion of the video information stream where active data is expected. The DACTIVE detection module 335 determines the first and last active pixel from each of the horizontal lines in each of the frames of the video information stream. The DACTIVE detection module 335 determines the first and the last horizontal line that includes DACTIVE information in each video frame of the video information stream. The DACTIVE detection module 335 sets corresponding flags in the registers 30 indicating the first and last horizontal lines that include DACTIVE information and the first and last pixels in each horizontal line.

At stage 1170, the letterbox detection module 340 determines the position of the active start 1010 and the position of the active end 1015. The letterbox detection module 340 identifies the first horizontal line that is non-black (e.g., the active start 1010) and identifies the last horizontal line that is non-black (e.g., the active end 1015). The letterbox detection module 340 determines whether a horizontal line is non-black by comparing it to the known black threshold on a color component, per-pixel basis. The letterbox detection module 340 indicates that a horizontal line is a black line if the number of black pixels in the horizontal line is above a threshold (e.g., 75% of pixels). The letterbox detection module 340 stores information corresponding to the position of the active start 1010 and the active end 1015 in the registers 30.

The letterbox detection module 340 determines the position of the window starts 1020 and 1030 and the window ends 1025 and 1035. The letterbox detection module 340 determines the actual starting pixel (e.g., the first non-black pixel) for the starts 1020, 1030 by determining the pixel where the non-black-line threshold is exceeded, and subtracting a quantity of pixels about equal to threshold quantity (e.g., N pixels, if the non-black-line threshold is N consecutive non-black-line pixels, or M pixels if the non-black-line threshold is a percentage of M consecutive pixels). Likewise, the letterbox detection module 340 determines the ends 1025, 1035.

Other embodiments are within the scope and spirit of the invention. For example, due to the nature of software, functions/modules described above can be implemented using software, hardware, firmware, hardwiring, or combinations of any of these. Features implementing functions may also be physically located at various positions, including being distributed such that portions of functions are implemented at different physical locations. For example, while FIG. 1 shows the timing detection module 10, and the video processor 20 as separate components, other configurations are possible (e.g., a single component containing the functionality of the timing module 10 and the video processor 20); the registers 30 can be located within other components within the system 5; the controller 35 can be contained within the video processor 20, etc.

While the above discussion disclosed modules designed to calculate specific final quantities and/or values (e.g., the polarity), the modules are also configured to calculate (and store in the registers 30) intermediate characteristic information (e.g., edge location) in the process of calculating the final quantities and/or values. For example, Appendix A includes several examples of intermediate characteristic information.

While the above discussion disclosed setting flags, and storing information, other methods of communication can be used to provide characteristic and/or other information to the video processor 20 (e.g., an interrupt can be asserted).

While the above discussion disclosed separate modules, each performing respective tasks, the functionality provided by each respective module can be combined with other modules (e.g., the letterbox detection module can include the capability to detect the polarity of an incoming signal).

Further, while the description above refers to “the invention”, more than one invention may be disclosed.

APPENDIX
VIP:CAP0_TIMING_DETECT_CNTL_STATUS · [R/W] · 32 bits · Access: 8/16/32 · VIDCAPDEC:0x110
DESCRIPTION: Timing Detection Control and Status Register

| Field Name | Bits | Default | Description |
|---|---|---|---|
| VID_VS_ACTIVITY | 0 | 0x0 | 0 = no activity, 1 = detect both rising and falling edge of VS (after |
| (Access: R) | | | three counts of rising edge and three counts of falling edge). |
| | | | If VS goes away for a long period of time, ACTIVITY returns to 0. |
| VID_HS_ACTIVITY | 1 | 0x0 | 0 = no activity, 1 = detect both rising and falling edge of HS (after |
| (Access: R) | | | three counts of rising edge and three counts of falling edge). |
| | | | If HS goes away for a long period of time, ACTIVITY returns to 0. |
| VID_VS_POLARITY_VALID | 2 | 0x0 | Status bit indicates engine has locked on to the correct polarity |
| (Access: R) | | | |
| VID_VS_POLARITY | 3 | 0x0 | 0 = active low 1 = active high. This is determined per hsync, and is |
| (Access: R) | | | outputed after 8 successful consecutive guesses without error. |
| VID_HS_POLARITY | 4 | 0x0 | 0 = active low 1 = active high. This is determined per hsync, and is |
| (Access: R) | | | outputed after 8 successful consecutive guesses without error. |
| VID_HS_POLARITY_VALID | 5 | 0x0 | Status bit indicates engine has locked on to the correct polarity |
| (Access: R) | | | |
| VID_CURRENT_FIELD | 6 | 0x0 | 0 = detect ODD 1 = detect EVEN |
| (Access: R) | | | |
| VID_PROGRESSIVE_DETECTED | 7 | 0x0 | 0 = Interlaced 1 = Progressive |
| (Access: R) | | | |
| VID_SYNC_SEL | 16-18 | 0x0 | 0 = external analog HS/VS pin |
| | | | 1 = DVI HS/VS pin |
| | | | 2 = internal HS/VS recovered from CCIR656 decoding |
| | | | 3 = VINDECO ACV sync |
| VID_BACK_PORCH_COUNT | 20-23 | 0x5 | Number of HS to skip after the VS, before determining other HS |
| | | | statistics |
| VID_HSYNC_NUM_SAMPLES | 24-27 | 0x5 | Total number of HS used to determine the period. This count |
| | | | begins after the Back porch. Using power of 2 encoding, 3 = 8, |
| | | | 4 = 16, 5 = 32, 6 = 64, 7 = 128, . . . 15 = 32768 |
| VID_TIMING_DETECTION_EN | 31 | 0x0 | Enable bit. 0 = off 1 = on. When on, the stream decoding mechanism |
| | | | which processes the signal is forced on, even if CAP_EN is off. |

TABLE 2
VIP:CAP0_TIMING_DETECT_THRESH · [R/W] · 32 bits · Access: 8/16/32 · VIDCAPDEC: 0x114
DESCRIPTION: Timing Detection Threshold registers

| Field Name | Bits | Default | Description |
|---|---|---|---|
| VID_VS_TOTAL_CHANGE_THRESH | 3:0 | 0x0 | Threshold for VID_VS_TOTAL register. |
| | | | 0 = 0, 1 = 2, 2 = 4, 3 = 8, 4 = 16, 5 = 32, 6 = 64, 7 = 128, . . . 15 = 32768 |
| | | | The difference (in number of crystal clocks) between current |
| | | | VID_VS_TOTAL and latched VID_VS_TOTAL to be reported as |
| | | | a change. |
| VID_VS_CNT_CHANGE | 7 | 0x0 | If the current VID_VS_TOTAL is different more than the amount |
| (Access: R) | | | of VID_VS_CNT_CHANGE_THRESH, this bit is set to 1. |
| VID_VS_CNT_CHANGE_CLR | 7 | 0x0 | Write a one to this bit clear the VID_VS_CNT_CHANGE to 0. |
| (Access: W) | | | |
| VID_HS_TOTAL_CHANGE_THRESH | 11:8 | 0x0 | Threshold for VID_HS_TOTAL register. |
| | | | 0 = 0, 1 = 2, 2 = 4, 3 = 8, 4 = 16, 5 = 32, 6 = 64, 7 = 128, . . . 15 = 32768 |
| | | | The difference (in number of crystal clocks) between current |
| | | | VID_HS_TOTAL and latched VID_HS_TOTAL to be reported as |
| | | | a change. |
| VID_HS_CNT_CHANGE | 15 | 0x0 | If the current VID_HS_TOTAL is different more than the amount |
| (Access: R) | | | of VID_HS_TOTAL_CHANGE_THRESH, this bit is set to 1. |
| VID_HS_CNT_CHANGE CLR | 15 | 0x0 | Write a one to this bit clear the VID_HS_CNT_CHANGE to 0. |
| (Access: W) | | | |
| VID_FIELD_LINE_CHANGE_THRESH | 29:28 | 0x1 | Threshold for VID_FIELD_LINE_TOTAL register. |
| | | | 0 = 0, 1 = 2, 2 = 4, 3 = 8, 4 = 16, 5 = 32, 6 = 64, 7 = 128, . . . 15 = 32768 |
| | | | The difference (in number of hsyncs/lines) between current |
| | | | VID_FIELD_LINE_TOTAL and latched |
| | | | VID_FIELD_LINE_TOTAL to be reported as a change. |
| VID_VS_LINE_CNT_CHANGE | 31 | 0x0 | If the current VID_FIELD_LINE_TOTAL is different more than |
| (Access: R) | | | the amount of VID_FIELD_LINE_CHANGE_THRESH, this bit |
| | | | is set to 1. |
| VID_VS_LINE_CNT_CHANGE_CLR | 31 | 0x0 | Write a one to this bit clear the VID_VS_LINE_CNT_CHANGE |
| (Access: W) | | | to 0. |

TABLE 3
VIP:CAP0_HS_COUNTER · [R/W] · 32 bits · Access: 8/16/32 • VIDCAPDEC: 0x118
DESCRIPTION: Timing Detection register for determining HS period and active time

| Field Name | Bits | Default | Description |
|---|---|---|---|
| VID_HS_TOTAL | 20:0 | 0x0 | The total number of crystal clocks between |
| (Access: R) | | | VID_HSYNC_NUM_SAMPLES numbers of HS active edges. |
| VID_HS_HIGH_CNT | 31:21 | 0x0 | The total number of crystal clocks that a single HS is active during |
| (Access: R) | | | its period |

TABLE 4
VIP:CAP0_VS_COUNTER · [R/W] · 32 bits ·
Access: 8/16/32 · VIDCAPDEC: 0x11C
DESCRIPTION: Timing Detection register for determining VS period

| Field Name | Bits | Default | Description |
|---|---|---|---|
| VID_VS_TOTAL | 20:0 | 0x0 | The total number of crystal clocks |
| (Access: R) | | | between 2 active edges of VS |

TABLE 5
VIP:CAP0_VS_LINE_COUNTER · [R/W] · 32 bits · Access: 8/16/32 · VIDCAPDEC: 0x120
DESCRIPTION: Timing Detection register for counting number of HSYNCs of a video frame/field

| Field Name | Bits | Default | Description |
|---|---|---|---|
| VID_FIELD_LINE_CNT_EQb | 0 | 0x0 | This indicates if the same amount of HS are found between two |
| (Access: R) | | | VS. Actually it is the LSB of the counted value decribed next |
| VID_FIELD_LINE_TOTAL | 11:1 | 0x0 | This is the total number of HS between 2 VS. This plus bit 0 is |
| (Access: R) | | | the total count value |
| VID_VS_PERIOD_CNT_EQb | 16 | 0x0 | This tells you if the same amount of HS are found inside two VS |
| (Access: R) | | | active regions. Actually it is the LSB of the counted value |
| | | | decribed next |
| VID_VS_PERIOD_LINE_CNT | 27:17 | 0x0 | This tells you the amount of HS found inside two VS active |
| (Access: R) | | | regions. This plus bit 16 is the total count value |

TABLE 6
VIP:CAP1_DACTIVE_H_COUNTER · [R/W] · 32 bits ·
Access: 8/16/32 · VIDCAPDEC: 0x2B4
DESCRIPTION: Timing Detection register which counts the number of
active pixels in a line and the first active pixel from the start of the line

| | | De- | |
|---|---|---|---|
| Field Name | Bits | fault | Description |
| VID_DACTIVE_PIX_START | 11:0 | 0x0 | Number of pixel clocks |
| (Access: R) | | | from the rising edge of |
| | | | HSYNC to the first pixel |
| | | | of DACTIVE = 1 |
| VID_DACTIVE_PIX_END | 27:16 | 0x0 | Total number of pixel |
| (Access: R) | | | clocks for DACTIVE = 1 |

TABLE 7
VIP:CAP1_DACTIVE_V_COUNTER · [R/W] · 32 bits · Access: 8/16/32 · VIDCAPDEC: 0x2B8
DESCRIPTION: Timing Detection register which counts the number of Dactive lines in a field/frame as well
as the starting of DACTIVE relative to the start of a field/frame

| Field Name | Bits | Default | Description |
|---|---|---|---|
| VID_DACTIVE_LINE_START | 11:0 | 0x0 | The line number of first DACTIVE in a field (rising edge of |
| (Access: R) | | | VSYNC for VSYNC polarity is positive or falling edge of |
| | | | VSYNC if VSYNC polarity is negative. Notice this VSYNC must |
| | | | be digital VSYNC |
| VID_DACTIVE_LINE_TOTAL | 27:16 | 0x0 | The total number of DACTIVE lines in a field |
| (Access: R) | | | |

TABLE 8
VIP:CAP1_LETTERBOX_CNTL · [R/W] · 32 bits ·
Access: 8/16/32 · VIDCAPDEC: 0x2C0
DESCRIPTION: Timing Detection register for
determining Letterbox status

| Field Name | Bits | Default | Description |
|---|---|---|---|
| HLETTERBOX_DETECTED | 27 | 0x0 | Horizontal windowing |
| (Access: R) | | | detected |
| VLETTERBOX_DETECTED | 31 | 0x0 | Vertical windowing |
| (Access: R) | | | detected |

TABLE 9
VIP:CAP1_LETTERBOX_COL_THRESH · [R/W] · 32 bits ·
Access: 8/16/32 · VIDCAPDEC: 0x2C4
DESCRIPTION: Timing Detection register for
specifying low colour levels of RGB and YCbCr

| Field Name | Bits | Default | Description |
|---|---|---|---|
| R_V_THRESH | 9:0 | 0x7 | Red or Cr colour threshold |
| G_Y_THRESH | 19:10 | 0x7 | Green or Y colour threshold |
| B_U_thresh | 29:20 | 0x7 | Blue or Cb colour threshold |

TABLE 10
VIP:CAP1_LETTERBOX_SUM_THRESH · [R/W] · 32 bits · Access: 8/16/32 · VIDCAPDEC: 0x2C8
DESCRIPTION: Timing Detection register for specifying Letterbox thresholds

| Field Name | Bits | Default | Description |
|---|---|---|---|
| LINE_SUM_THRESH | 11:0 | 0x80 | Each pixel is considered black or white (depending on threshold |
| | | | specified). As the counting is done per line, the line is considered |
| | | | black or not depending on this threshold. Used in Vertical |
| | | | Letterbox detection |
| WINDOW0_START_THRESH | 23:16 | 0x5 | During horizontal letterboxing, this would be the start of the first |
| | | | window, which may not be the only window in the case of |
| | | | Macrovision, etc. The threshold indicates what summation is |
| | | | necessary to determine the first window. |
| WINDOW1_START_THRESH | 31:24 | 0x5 | During horizontal letterboxing, this would be the start of the |
| | | | second window, if it exists. The threshold indicates what |
| | | | summation is necessary to determine the second window. |

TABLE 11
VIP:CAP0_LETTERBOX_VLINE_FRAME0 · [R/W] · 32 bits ·
Access: 8/16/32 · VIDCAPDEC: 0x13C
DESCRIPTION: Timing Detection register for
Verticle Letterbox, FRAME0, START and END

| Field Name | Bits | Default | Description |
|---|---|---|---|
| ACTIVE_START | 11:0 | 0x0 | Line which active video starts, |
| (Access: R) | | | Letterbox line Start |
| ACTIVE_END | 27:16 | 0x0 | Line which active video |
| (Access: R) | | | ends, Letterbox line End |

TABLE 12
VIP:CAP0_LETTERBOX_VLINE_FRAME1 · [R/W] · 32 bits ·
Access: 8/16/32 · VIDCAPDEC: 0x140
DESCRIPTION: Timing Detection register for
Verticle Letterbox, FRAME1, START and END

| Field Name | Bits | Default | Description |
|---|---|---|---|
| ACTIVE_START | 11:0 | 0x0 | Line which active video starts, |
| (Access: R) | | | Letterbox line Start |
| ACTIVE_END | 27:16 | 0x0 | Line which active video |
| (Access: R) | | | ends, Letterbox line End |

TABLE 13
VIP:CAP0_LETTERBOX_HLINE_FRAME0 · [R/W] · 32 bits ·
Access: 8/16/32 · VIDCAPDEC: 0x144
DESCRIPTION: Timing Detection register for
Horizontal Letterbox, FRAME0, START0 and START1

| Field Name | Bits | Default | Description |
|---|---|---|---|
| WINDOW0_START | 11:0 | 0x0 | Pixel which is the start of |
| (Access: R) | | | the first window |
| WINDOW1_START | 27:16 | 0x0 | Pixel which is the start of |
| (Access: R) | | | the second window, if it exists |

TABLE 14
VIP:CAP0_LETTERBOX_HLINE_FRAME1 · [R/W] · 32 bits ·
Access: 8/16/32 · VIDCAPDEC: 0x148
DESCRIPTION: Timing Detection register for
Horizontal Letterbox, FRAME1, START0 and START1

| Field Name | Bits | Default | Description |
|---|---|---|---|
| WINDOW0_START | 11:0 | 0x0 | Pixel which is the start of |
| (Access: R) | | | the first window |
| WINDOW1_START | 27:16 | 0x0 | Pixel which is the start of |
| (Access: R) | | | the second window, if it exists |

TABLE 15
VIP:CAP0_DVI_FIRST_FIELD_DETECT_RANGE · [R/W] · 32 bits · Access: 8/16/32 · VIDCAPDEC: 0x78
DESCRIPTION: Vsync correction and First Field detection register

| Field Name | Bits | Default | Description |
|---|---|---|---|
| CAP_DVI_FIRST_FIELD_LEFT_BOUND | 15:4 | 0x0 | Leftmost limit (from Hsync active edge) for detecting Vsync |
| | | | edge. 12bit signed number. |
| CAP_DVI_FIRST_FIELD_RIGHT_BOUND | 27:16 | 0x0 | Rightmost limit (from Hsync active edge) for detecting |
| | | | Vsync edge. 12bit signed number. |
| CAP_DVI_LR_DETECT_MODE | 29 | 0x0 | Mode selection bit |
| CAP_DVI_FIRST_FIELD_DETECT_RANGE_EN | 31 | 0x0 | Enable bit for this register |

TABLE 16
VIP:CAP0_DVI_FIRST_FIELD_OUTPUT · [R/W] · 32 bits ·
Access: 8/16/32 · VIDCAPDEC: 0x7C
DESCRIPTION: VS and HS status of the
CAP0_DVI_FIRST_FIELD_DETECT_RANGE

| Field Name | Bits | Default | Description |
|---|---|---|---|
| CURR_VS_POS | 11:0 | 0x0 | Vsync count |
| (Access: R) | | | |
| H_TOTAL | 27:16 | 0x0 | Hsync count |
| (Access: R) | | | |

What is claimed is:

1. A video signal identification system comprising:
an input module configured to receive an unknown video signal;
a video signal processing module configured to process known video signals; and
a processor coupled to the input module and to the video signal processing module and configured to determine and store information indicative of characteristics of the unknown video signal such that the unknown video signal becomes a known video signal that can be processed by the video signal processing module.

2. The system of claim 1 wherein the processor is configured to:
detect a polarity of at least a sub-portion of the unknown video signal;
detect the presence of a vertical synchronization signal in the unknown video signal;
detect the presence of a horizontal synchronization signal in the unknown video signal;
provide, if a vertical synchronization signal is present in the unknown video signal, information related to a characteristic of the vertical synchronization signal;
provide, if a horizontal synchronization signal is present in the unknown video signal, information related to a characteristic of the horizontal synchronization signal;
wherein the video signal processing module is configured to recognize a type of the unknown video signal based upon the characteristic information provided by the processor.

3. The system of claim 2 wherein the processor is further configured to determine a vertical synchronization period of vertical synchronization pulses included in the vertical synchronization signal.

4. The system of claim 3 wherein the processor is further configured to determine a consistency of the vertical synchronization signal by tracking the vertical synchronization period.

5. The system of claim 2 wherein the processor is further configured to determine a horizontal synchronization period of horizontal synchronization pulses included in the horizontal synchronization signal.

6. The system of claim 5 wherein the processor is further configured to determine a consistency of the horizontal synchronization signal by tracking the horizontal synchronization period.

7. The system of claim 2 wherein the processor is further configured to determine whether the unknown video signal includes letterboxed video.

8. The system of claim 7 wherein the processor is further configured to determine starting and ending locations of a letterboxed image included in the unknown video signal.

9. The system of claim 2 wherein the processor is further configured to determine whether the unknown video signal includes interlaced video.

10. The system of claim 2 wherein the processor is further configured to determine a location of first and last pixels of a horizontal line corresponding to a DACTIVE region of the unknown video signal.

11. A video signal identification method comprising:
receiving an unknown video signal;
converting the unknown video signal into a known video signal by:
determining information indicative of characteristics of the unknown video signal;
storing the information in a memory; and
processing the known video signal using the information.

12. The method of claim 11 wherein converting the unknown video signal into the known video signal includes:
detecting a polarity of at least a sub-portion of the unknown video signal;
detecting the presence of a vertical synchronization signal in the unknown video signal;
detecting the presence of a horizontal synchronization signal in the unknown video signal;
providing, if a vertical synchronization signal is present in the unknown video signal, information related to a characteristic of the vertical synchronization signal; and
providing, if a horizontal synchronization signal is present in the unknown video signal, information related to a characteristic of the horizontal synchronization signal.

13. The method of claim 12 wherein converting the unknown video signal into the known video signal includes determining a vertical synchronization period of vertical synchronization pulses included in the vertical synchronization signal.

14. The method of claim 13 wherein converting the unknown video signal into the known video signal includes determining a consistency of the vertical synchronization signal by tracking the vertical synchronization period.

15. The method of claim 12 wherein converting the unknown video signal into the known video signal includes determining a horizontal synchronization period of horizontal synchronization pulses included in the horizontal synchronization signal.

16. The method of claim 15 wherein converting the unknown video signal into the known video signal includes determining a consistency of the horizontal synchronization signal by tracking the horizontal synchronization period.

17. The method of claim 12 further comprising determining whether the unknown video signal includes letterboxed video.

18. The method of claim 17 further comprising determining starting and ending locations of a letterboxed image included in the video signal.

19. The method of claim 12 further comprising determining if the unknown video signal includes interlaced video.

20. The method of claim 12 further comprising determining a location of first and last pixels of a horizontal line corresponding to a DACTIVE region of the unknown video signal.
